(19) United States
(12) Patent Application Publication
(10) Pub. No.: US 2025/0237247 A1
(43) Pub. Date: Jul. 24, 2025

(54) A BLIND MECHANICAL FASTENING SYSTEM FOR CONNECTING MEMBERS TO ONE ANOTHER

(71) Applicant: ALAN STRANG, Maroochydore (AU)

(72) Inventor: ALAN STRANG, Maroochydore (AU)

(73) Assignee: ALAN STRANG, Maroochydore (AU)

(21) Appl. No.: 18/833,420

(22) PCT Filed: Feb. 1, 2023
(86) PCT No.: PCT/AU2023/050064

§ 371 Date: Jul. 26, 2024

(30) Foreign Application Priority Data
Feb. 10, 2022 (AU) 2022900272
May 2, 2022 (AU) 2022901146
Aug. 22, 2022 (AU) 2022902391
Oct. 19, 2022 (AU) 2022903075

(51) Int. Cl. F16B 5/00; F16B 5/02; F16B 21/06; F16B 39/10

(52) U.S. Cl. CPC F16B 5/0088; F16B 5/0024; F16B 5/025; F16B 5/0266; F16B 21/065; F16B 39/10

(57) ABSTRACT

According to the present invention, a blind fastening system for connecting members to one another comprises two parts; a structure containing a conical nut, matched to a threaded rod engaged to a lineal guide and a driven gear meshed to a driving gear having a tooling interface as the first part and; a separate structure containing anchor plates with springs and spring supports to act on and retain the conical nut of the first part. The blind fastening system also has a friction collar, a drive shaft, a retractable mechanism, a funnel tool guide, dowels and aligning & restricting guides.

### FIELD OF INVENTION

This invention relates to improvements in blind fastening systems for connecting members to one another particularly in a number of industries including the construction, fire protection and security industries where conventional blind fastening systems are unable to be used due to limited accessibility, aesthetic requirements and design constraints including compartmentalisation of structures.

### BACKGROUND OF INVENTION

A variety of fastening systems are common in many industries and used in connecting members to one another. Conventional non-blind fastening systems are commonly in-line driven and in full view or in physical accessible proximity to the installer and are fastened or loosened using conventional tooling. There are some limited access areas where ninety degree drives or flexible drives can be used, in bespoke applications. A conventional fastening system may consist of bolts and nuts, which requires access from both sides and may be driven axially by conventional tooling, for example, a socket, wrench, spanner, screw driver or similar tooling using straight, flexible or ninety degree tooling interfaces.

There are cases when members are required to be connected to one another where limited accessibility and design constraints are available including compartmentalisation of structures which may not allow for the use of conventional fastening systems and conventional tooling. In a few cases, blind fastening systems can be used. Removable access panels can also allow conventional tooling access but at a higher cost due to requirement of a bespoke design.

Blind mechanical fastener systems include captured nuts, split nuts, tek-screws, screws, and fasteners with expanding anchors such as anchor bolts, rivet bolts, rivets and applications where access is from one side only, but these require fine tolerances and accurate alignment of the connecting members. There are blind fasteners which require less accurate alignment such as a toggle type of fastener system utilising single or multiple legs or barbs as anchors that expand once the fastener is activated in place, but these are not preferred for heavy duty applications.

Prior art such as the U.S. Pat. No. 5,152,582 discloses “A self-aligning fastener system having stud engaging resilient legs”, which utilises legs that engage with the stud, but are for light duty fastening and USA Patent No. 2011/0188962 A1 discloses a “Self aligning fastener assembly”, which utilises a dynamically exposed secondary sleeve with an external and internal thread that allows the captive bolt to engage with the target well before conventional fastener engagement occurs; in this case accurate axial alignment is still required.

Another U.S. Pat. No. 6,149,213 titled “Blind Latch Keeper” having a keeper sub-assembly which is mounted in a fixed position for engagement with a keeper pin, attached to a movable entity. The keeper pin, in the form of an elongated shaft is received into a keeper sub-assembly, permitting alignment when engaging with the keeper sub-assembly; in this case the keeper subassembly engages on one side of the keeper pin so it can be easily released when moved in the opposite direction. The Blind Latch Keeper does not provide a novel linear movement of the keeper pin via a slot and key, nor does it move linearly or axially via a driven threaded gear and nor does it have novel adapter plates where the adapter plates that compensate for misalignment have a uniquely shaped aperture to provide a minimum force to accept the conical nut and maximise the contact area on the reverse side of the conical nut for greater tensile strength one engaged, as described in the principles set out in the consistory clauses of this invention's specification. The Blind Keeper Latch is generally a light duty clip on/off latch system specifically designed for temporarily keeping in place window blinds, door panels and the like.

### OBJECT OF THE INVENTION

It is therefore an object of the present invention to provide a blind fastening system to connect members to one another which overcomes the disadvantages of the prior art or at least provides a useful alternative to prior art devices.

### STATEMENT OF INVENTION

According to the present invention, a blind fastening system for connecting members to one another comprises two parts; a structure containing a conical nut, matched to a threaded rod engaged to a lineal guide and a driven gear meshed to a driving gear as the first part and; a separate structure as the second part, containing anchor plates with springs and spring supports to act on and retain the conical nut of the first part.

Preferably the driven gear has internal threads to accommodate the threaded rod. Preferably the driving gear can be configured at any angle to the driven gear.

Preferably the driving gear has a tooling interface

Preferably the driving gear's a tooling interface is driven by and connected to a drive shaft.

Preferably the drive shaft has a tooling interface.

Preferably the tooling interface has a funnel tool guide.

Preferably the conical nut has a tooling interface on the tapered side.

Preferably the conical nut's tooling interface is accessed through a contingent hole in the member of the first part.

Preferably the conical nut has internal threads matched to the threaded rod.

Preferably the conical nut has a restricting extension.

Preferably the conical nut has a friction surface on the retaining side.

Preferably the threaded rod's lineal guide is in the form of a slot and retractable key.

Preferably the threaded rod has a conical end.

Preferably the threaded rod has a tooling interface on the conical end.

Preferably a retractable key which corresponds with the slot in the threaded rod is integrated into the structure of the first part.

Preferably a friction collar is integrated into the structure of the second part.

Preferably the anchor plates act on a friction collar.

Preferably the anchor plates are split and move laterally.

Preferably the anchor plates form a singular central aperture.

Preferably the anchor plates' aperture is in the form of an elliptical type aperture.

Preferably the anchor plates work in unison when making contact with the conical nut and conical end of the threaded rod.

Preferably the anchor plates are retained by the structure of the second part.

Preferably the anchor plates' retaining structure of the second part has movable fingers to temporarily retain the conical nut.

Preferably the anchor plates have recesses for the conical nut's restricting extension.

Preferably the anchor plates have aligning guides.

Preferably the anchor plates have centralising springs.

Preferably the centralising springs have spring supports.

Preferably the blind fastening system incorporates aligning dowels.

Preferably a slotted hole/spline connects the drive to the worm gear.

Preferably the drive depresses axially to activate the retractable key.

Preferably the drive and retractable key is spring loaded.

A method of utilising a blind fastening system for connecting members to one another comprises two parts; a structure containing a conical nut, matched to a threaded rod engaged to a lineal guide and a driven gear meshed to a driving gear as the first part and; a separate structure as the second part containing anchor plates with springs and spring supports to act on and retain the conical nut of the first part.

### BRIEF DESCRIPTION OF THE DRAWINGS

An embodiment of this invention, purely by way of example, will now be described in more detail with reference to the accompanying drawings FIG. 1, FIG. 2, and FIG. 3 which are cross-sectional drawings of a blind fastening system illustrating some sectioned and un-sectioned areas for clarity and FIG. 4 which is an isometric drawing with cutaways for further clarity.

In the accompanying drawings of FIG. 1, FIG. 2, FIG. 3 and FIG. 4, FIG. 1. illustrates the blind fastening system in a non-connected state;

FIG. 2. illustrates the blind fastening system in a semi-connected state;

FIG. 3. illustrates the blind fastening system in a fully-connected state;

FIG. 4. illustrates the blind fastening system in a non-connected state with the threaded rod/conical nut protruding. This configuration is in a component styled arrangement for universal application.

### DETAILED DESCRIPTION OF THE INVENTION

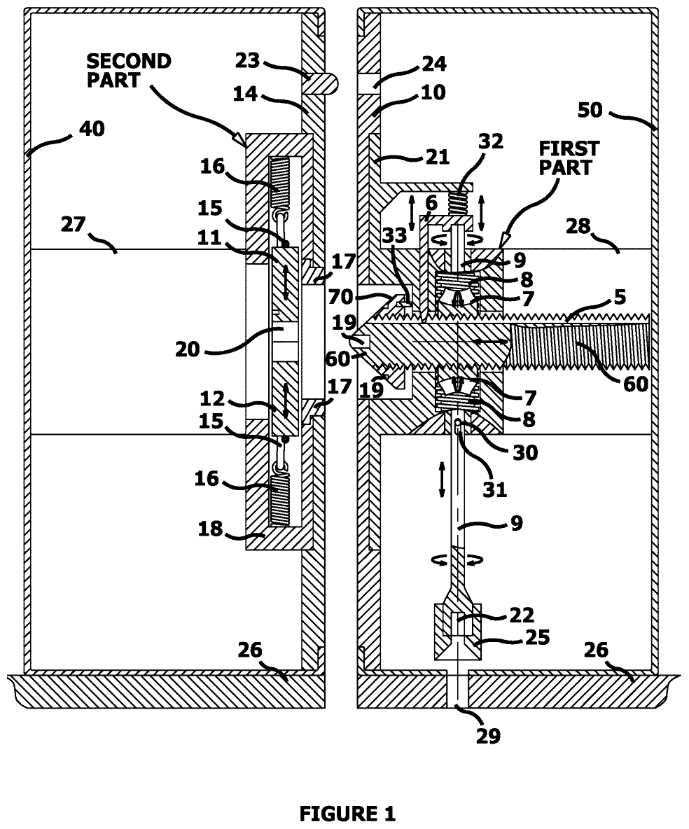

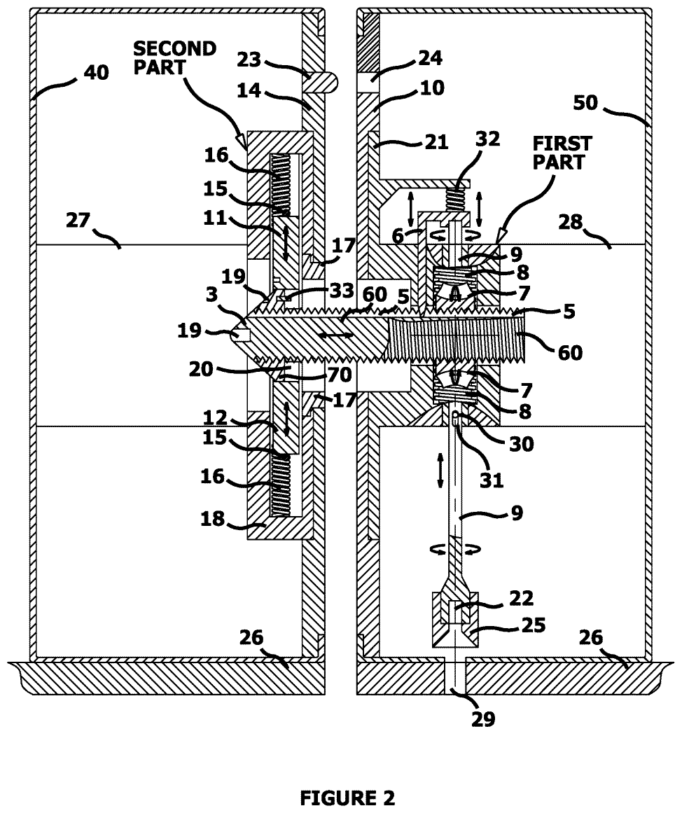

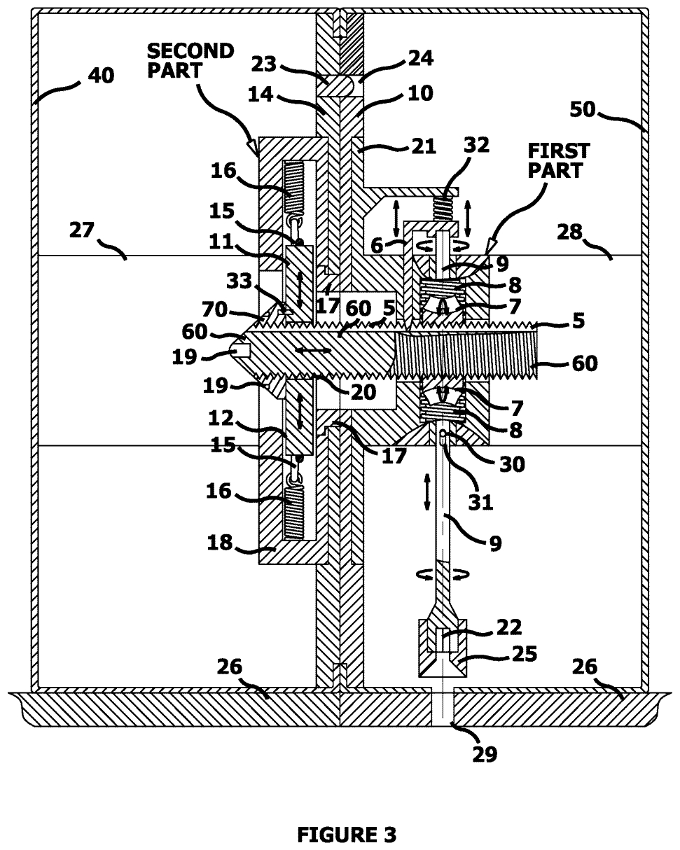

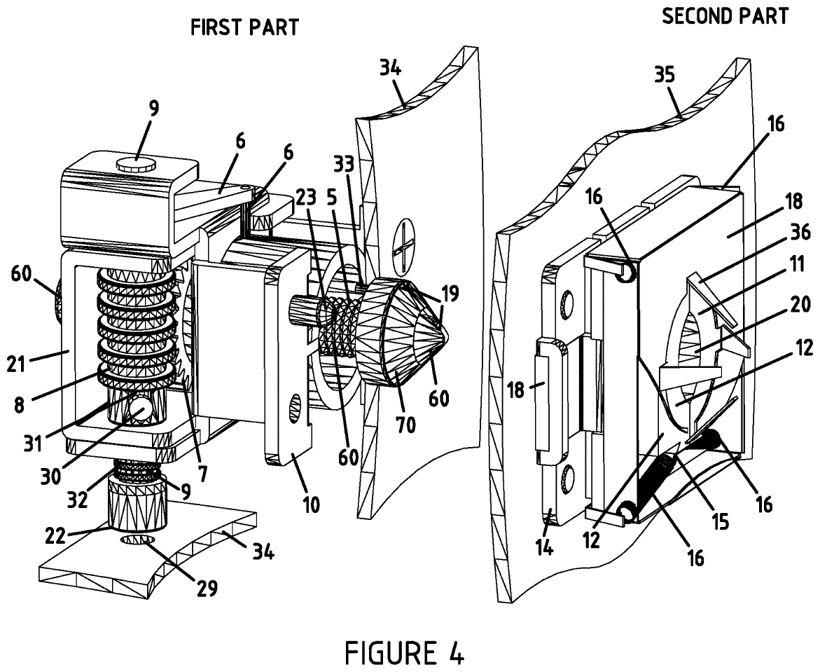

FIG. 1, FIG. 2 and FIG. 3 illustrates a blind fastening system with two parts for connecting members 40 and 50 together. FIG. 4 illustrates a blind fastening system that can be attached to members 34 & 35 for connecting together. In FIG. 4 and in particular FIG. 1, FIG. 2 and FIG. 3, the first part (21) of the blind fastening system comprises a threaded rod at 60, and a conical nut with internal threads at 70 and restricting extension at 33 with a lineal guide in the form of a slot at 5, and a retractable matching key at 6, a driven gear with internal threads in the form of a worm gear wheel at 7, a driving gear in the form of a worm gear at 8 with a drive shaft at 9 and tooling interfaces at 19 and 22, a funnel tool guide at 25, a slotted aperture at 30 and a coupling pin 31, a spring at 32 all contained in a structure at 21. The second part (18) of the blind fastening system comprises anchor plates at 11 & 12 with a singular central aperture at 20, spring supports at 15, centralising springs at 16 all contained in a structure at 18. There is a friction collar at 17 and a dowel combination at 23 and 24. In general, face plates are shown at 10 & 14, support ties at 27 & 28, lining material at 26, a tooling access aperture at 29 and conical nut retaining movable fingers at 36.

In order to operate the blind fastening system, the drive shaft 9 rotates by means of a tooling interface at 22 accessed through a tooling access hole at 29 which drives and rotates the worm gear 8, which then meshes with and rotates the worm gear wheel 7, which enables the threaded rod 60 and conical nut 70 to move linearly, guided by slot 5 and retractable key 6, towards the singular central aperture at 20 and against the anchor plates 11 & 12 as illustrated in FIG. 2. The force on the anchor plates 11 & 12 from the tapered shape of the conical nut 70 facilitates the anchor plates to overcome the springs at 16 tension and to split open laterally, allowing the conical nut 70 to pass through the singular central aperture 20. The anchor plates 11 & 12 then return to their original position once the conical nut 70 with a restricting extension 33 has passed through the anchor plates and aligned with the aperture. The anchor plates 11 & 12 close by means of centralising springs at 16 and spring supports at 15, settling around the threaded rod 60 allowing the blind fastening system to now be tightened.

To tighten the blind fastening system, the rotational direction of the worm gear drive assembly 7, 8, 9 and 22 is then reversed, and the conical nut 70 pulls up against the opposite side of the anchor plates 11 & 12 while travelling linearly restricted by the slot 5 and retractable key 6 as illustrated in FIG. 2, allowing the two members 40 & 50 and face plates 14 and 10 to tighten together. The blind fastening system can be loosened by changing the direction of the worm gear drive assembly, 7, 8, 9 and 22 again to allow the threaded rod 60 to rotate completely through the worm gear wheel 7 or by loosening the conical nut 70 through a contingent hole in member 40, in line with the tooling interface at 22.

The blind fastening system can also be loosened by depressing the drive 9, to overcome the spring 32 to retract the key 6 from slot 5 and by then rotating the drive 9 in a suitable direction in its depressed state to drive and rotate the worm gear 8 via the slotted hole 31 and coupling pin 30, which then meshes with and rotates the worm gear wheel 7, which enables the threaded rod 60 to rotate and uncouple/unscrew from the conical nut 70 which is restricted from rotation by means of a restricting extension at 33 and retained in place by the movable fingers at 36. The blind fastening system will revert back to a lineal guided threaded rod 60 movement once the retracted key 6 is released and the threaded rod 60 rotates until the released key 6 locates back into the slot 5 of the threaded rod 60.

### VARIATIONS

It will be realised that the foregoing has been given by way of illustrative example only and that all other modifications and variations as would be apparent to persons skilled in the art are deemed to fall within the broad scope and ambit of the invention as herein set forth.

For example the anchor plates 11 & 12 may pivot laterally rather than slide laterally apart in order to accept the conical nut 70. Further the threaded rod's lineal guide may be an integrated flat surface as part of the threaded rod instead of a slot 5 and the containing structure, shaped to suit the integrated flat surface instead of a key 6. Also, the function that allows the key 6 to be engaged and disengaged, can be removed and a permanent key 6 integrated into structure of the first part which will then restrict the threaded rod to linear movement only.

The anchor plates 11 & 12 may be multiple or singular which slide laterally or pivot laterally or move in other planes to accept the conical nut 70. Alternatively anchor plates may be configured to the first part of the blind fastening system and may act on the conical nut and threaded rod configured to the second part of the blind fastening system. Also the driven worm gear wheel 7 and driving worm gear 8 may be in the form of general spur gears or helical spur gears including bevel and pinion type gears, even toothed belt & pulley combinations, all types of drive systems to facilitate fastening in different planes and angles and with different ratios.

Further to the blind fastening system, more than one driven gear 7 and driving gear 8 set may be used in sequence with another assembled gear set to facilitate configurations that require more compound fastening planes due a variety of constraints. An example may be a blind fastening system where two approximate right angle blind fastening system can be used in tandem to form a Z, II or C configuration. The number of blind tandem fastening systems used in sequence can be unlimited.

Further to the blind fastening system as in FIG. 4, the first part of the blind fastening system and second part of the blind fastening system may be adapted to be removably secured not only to members as set out in this specification, but also to other structures that may need securing such as equipment to any type of structure, for example, where the second part of the blind fastening system is mounted in a wall structure and the first part of the blind fastening system is mounted to equipment and the equipment is then secured to the wall via an a small pluggable aperture positioned outside the line of sight. The blind fastening system may also be integrated into an exposed timber beam where it connects to columns protected with passive fire systems. The blind fastening system will be isolated from heat transfer via conduction as there will be no exposed fasteners and any small access hole can be plugged with fire retardant to maintain fire rating integrity and rely on the exposed beam's charring properties to achieve suitable fire ratings.

Also, an alternative to a friction collar can be a coarse surface such as knurling, utilised between the anchor plates and the clamping surfaces, to prevent the anchor plates from moving under lateral load. Accurate alignment aids in the form of stationary or spring loaded/retractable dowel locating pins 23 can also be integrated into the structure 14 of the second part and the dowel locating pin mating apertures 24 into structure 10 of first part. Also, the conical nut 70 could easily form part of the threaded rod 60 to form a single unit or threaded partially to lock against the threaded rod.

In yet a further variation of the invention, a structure containing a stationary captured nut, a conical nut with a reverse thread, a threaded rod with a reverse thread on the end to suite the conical nut. The threaded rod complete with the conical nut travels linearly via the matched captured nut when the threaded rod rotates by means of a tool via an axial tooling interface as the first part and; a separate structure as the second part, containing anchor plates with springs and spring supports to act on and retain the conical nut of the first part.

Even further the blind fastening system may be electronically adapted with specialised digital features including electric drive motors, batteries, hydraulics, control sensors, depth indicators and micro cameras for identifying full engagement; these features may be captured within the members and may be activated using hardwiring or wireless type technology.

Also, the blind fastening system's second part may make use of a remote mechanism controlled by the assembler, to adjust the aperture open or closed by shifting the anchor plates laterally, to allow the conical nut of the first part to be either released or captured when the fastening system is in an engaged, but loosened state.

All such variations fall within the scope of the present invention. Throughout the description and claims to this specification the word “comprise” and variations of that word such as “comprises” and “comprising” are not intended to exclude other additives components integers or steps.

The reference in this specification to any prior publication (or information derived from it), or to any matter which is known, is not, and should not be taken as an acknowledgement or admission or any other form of suggestion that the prior publication (or information derived from it) or known matter forms part of the common general knowledge in the field of endeavour to which this specification relates.

1. A blind fastening system for connecting members to one another comprises two parts; a structure containing a conical nut with a restricting extension, matched to a threaded rod engaged to a retractable lineal guide and a driven gear meshed to a driving gear having a tooling interface as the first part and; a separate structure containing anchor plates with springs and spring supports to act on and retain the conical nut of the first part.

2. The blind fastening system of claim 1 where the driving gear can be at any angle to the threaded rod.

3. The blind fastening system of claim 1 where the driven gear has internal threads.

4. The blind fastening system of claim 1 where the driving gear has a drive shaft with a tooling interface.

5. The blind fastening system of claim 4 where the drive shaft connects to the worm gear via a slotted hole/spline.

6. The blind fastening system of claim 4 where the drive shaft can be axially moved to activate a retractable key via the slotted hole/spline.

7. The blind fastening system of claim 4 where the drive shaft and retractable key is spring loaded.

8. The blind fastening system of claim 1 where the threaded rod has a conical end.

9. The blind fastening system of claim 1 where the conical nut has internal threads matched to the threaded rod.

10. The blind fastening system of claim 1 where the threaded rod's lineal guide consists of a slot and retractable key.

11. The blind fastening system of claim 1 where the anchor plates are split and move laterally.

12. The blind fastening system of claim 1 where the anchor plates form a singular central aperture.

13. The blind fastening system of claim 12 where the singular central aperture is in the form of an elliptical type aperture.

14. The blind fastening system of claim 1 where the anchor plates work in unison when making contact with the conical nut of 8's claim conical 15 end of the threaded rod.

15. The blind fastening system of claim 1 where the anchor plates have aligning guides.

16. The blind fastening system of claim 1 where the anchor plates have centralising springs.

17. The blind fastening system of claim 1 where the anchor plates have recesses for the conical nut's restricting extension.

18. The blind fastening system of claim 16 where the centralising springs have spring supports.

19. The blind fastening system of claim 1 where the blind fastening system may incorporate aligning dowels.

20. A method of utilising a blind fastening system for connecting members to one another comprises two parts; a structure containing a conical nut with a restricting extension, matched to a threaded rod engaged to a retractable lineal guide and a driven gear meshed to a driving gear having a tooling interface as the first part and; a separate structure containing anchor plates with springs and spring supports to act on and retain the conical nut of the first part.
